(19) United States
(12) Patent Application Publication
(10) Pub. No.: US 2010/0223815 A1
(43) Pub. Date: Sep. 9, 2010

(54) Footwear with integrated display

(76) Inventor: Brian Keith McGarity, San Antonio, TX (US)

Correspondence Address: THE MATTHEWS FIRM, 2000 BERING DRIVE, SUITE 700, HOUSTON, TX, 77057, US

(21) Appl. No.: 12/381,059

(22) Filed: Mar. 6, 2009

(51) Int. Cl. A43B 23/00; H04N 7/00

(52) U.S. Cl. 36/136; 348/552; 348/E07.001

(57) ABSTRACT

An article of footwear comprising a display device integrated within its body. At least one audio device is also integrated within the body and is in communication with the display device. A receiver, integrated within the body, communicates audio and video signals, which can include live network television broadcasts and other streaming content, to the display device and audio device. An integrated or remote processor and data storage medium can receive, store, and communicate audio and/or video files for playback using the display and audio devices. A unique luxury item is thereby provided, suitable for the dual purpose of providing the convenience of a portable television and video/music player, coupled with an enhanced means for expression of affluence or a selected lifestyle.

### FIELD

The present invention relates to an article of footwear having an integrated display device for enabling the wearer and other onlookers to experience broadcast television, video, and/or audio files in an extremely portable fashion, and enabling a wearer to enhance his or her appearance through selective combinations of displayed visual material with the footwear.

### BACKGROUND

In many segments of the population, footwear has been elevated from a necessity for protection of a wearer's feet to a luxury item. An interested buyer will often pay several hundred dollars, or more, for a pair of designer sneakers or dress shoes, adhering to the familiar adage, “clothes make the man.” Expensive and/or unique footwear is not only usable as a display of affluence, but is also usable as a medium for expression. Clothing can often be used as an indicator for mood, political, educational, or religious affiliations, or as a representation of a certain lifestyle.

With the advent of modern technology, various electronic devices have been miniaturized. It is possible to acquire miniature televisions, audio players, video playback devices, telephones, computers, and many more modern conveniences, all of which comfortably fit within a pocket or the palm of the hand. Many of these devices are wearable, being provided with or alongside holders or similar attachments that enable fastening or clipping of the device to a belt or other article of clothing. Since many of these devices and their fastening members can be worn externally, decorative exteriors for these devices have become fashionable.

Few means of expression are as effective as visual media. The impact of the news is much greater alongside video footage or coverage of an event. A song becomes far more expressive when presented as a music video. Viewing of a sporting event on television is far superior to listening to a radio broadcast covering the event. Additionally, few means of expression are as varied and sundry as visual media. While a painting or a sculpture remains fixed once created, no two scenes of a television broadcast are identical, the visual image moving constantly.

To date, no product exists that seamlessly combines an integrated display device with an article of footwear, providing not only all of the advantages inherent to portable televisions and audio/video playback devices, but enabling a means of expression through mode of dress that has yet to be achieved. Where an expensive pair of sneakers provides a limited degree of expression, an article of footwear having a display device integrated therein enables an even greater range of expression to communicate an enhanced lifestyle. Through variation of the displayed material, coupled with possible use of audio material, the range of messages and expressions that can be conveyed through such a product are limitless.

Existing display devices within footwear have been limited to sporting and athletic devices, coupled with sensing units for determining speed, acceleration, weight, and other data, which can then be displayed locally or remotely.

A need exists for an article of footwear that takes advantage of existing audio and video technology to combine an article of footwear with integrated display and audio devices, and a receiver for enabling the devices to receive and process live network broadcast signals and similar streaming audio and/or video data.

A further need exists for an article of footwear that, in addition to or in lieu of the above, can utilize data processing and storage capability to download, store, manipulate, and playback audio and video files.

A need also exists for an article of footwear having an integrated display device that can be viewed when worn by an individual, or when removed from the individual, being usable both for viewing and as a medium of expression.

The embodiments herein meet these needs.

### SUMMARY

The present invention relates to an article of footwear having an integrated display device.

The footwear can include a body adapted for being worn on an individual's foot. Types of usable footwear can include high tops, basketball shoes, canvas shoes, cleated shoes, cross trainers, hiking shoes, running shoes, tennis shoes, walking shoes, other types of athletic or casual shoes, dress shoes, including slip-on shoes and wingtips, or any other variety of wearable footwear for men, women, or children.

A display device is integrated within the body of the footwear. The display device can include a portable liquid crystal display or plasma screen, or other types of display devices having dimensions able to fit within the body of a standard shoe. In an embodiment, the length and width of the display device can range from one inch to six inches, or more.

While the display device can be integrated with any portion of the body, in an embodiment of the invention, the display device can be built into either side of the tongue of the footwear, the toe of the footwear, either side of the body of the footwear, or other similar locations. In a further embodiment of the invention, the tongue can be rotatably disposed on the body of the footwear, such as through use of a rotating bracket, to enable the display device to be viewed from a variety of orientations. The tongue can also include a fastener, locking device, or similar type of fastening means to enable the tongue to be secured in a raised position to facilitate viewing. For example, Velcro™ could be used to adhere the tongue to the top of the body, or an extendable member could be used to prop the tongue in a raised position, similar to an easel tripod. A pivotable locking bar could also be used to tilt the tongue and display device forward, clicking or locking into place to support the display device in an orientation that facilitates viewing.

Integration of the display device with a rotatable and/or pivotable tongue of the footwear can enable the device to be readily seen by onlookers while the shoe is worn, and rotated to face the wearer when it is desirable to conceal the display device, such as during rain or other inclement weather. Additionally when the footwear is removed, the display device can be readily viewable from any orientation. Alternatively, integration of the display device with the toe of the footwear can enable the device to be readily seen by onlookers while the shoe is worn, while enabling the wearer to readily view the display device as well, such as by propping his or her feet on a table or similar surface, or simply by looking in a downward direction. Integration of the display device with the outer side of the footwear can provide aesthetic decoration visible to onlookers while the shoe is worn, while enabling the wearer to view the display device when the shoe is removed. Integration of the display device with the inner side of the footwear can be visible to onlookers while enabling the wearer to view the display device by crossing his or her legs or assuming a similar seated position.

In an embodiment of the invention, the display device can be rotatably mounted to the body of footwear, pivotably mounted to the body, or combinations thereof. It is also possible for the display to be fixedly mounted to the body. In a further embodiment of the invention, a portion of the display device can be removable from the footwear to prevent damage and deter theft. For example, the screen of the display device could be removable while circuitry or other components remain integrated within the body. A removable portion of the display device could then be interchangeably used with a variety of articles of footwear having integrated circuitry and a mounting location for receiving the removable portion.

At least one speaker or similar audio output device is also integrated within the body. The audio device(s) can be integral with the display device, or separate therefrom and in wired or remote communication with the display device.

A receiver can be integrated within the body of the footwear for receiving audio and/or video signals. The receiver can be integral with, or separate from, the display device and/or the audio device(s). The receiver communicates received audio and video signals to the display device and audio device(s), where internal circuitry processes the signals to create images and sounds. In a preferred embodiment of the invention, the receiver can be adapted to receive network broadcast signals, enabling a user to view live television. For example, the receiver can include a digital receiver for receiving a digital television signal, an antenna or analog receiver for receiving an analog broadcast, or other similar types of receivers able to receive remote signals and communicate the signals to the display device and audio device(s).

In a further embodiment of the invention, the footwear can include a processor and data storage integrated within the body, or remote from the body and in communication with the receiver. The processor and data storage are usable to receive, store, process, and transmit audio and/or video files for playback using the display device and audio device(s) of the footwear.

The footwear can further include a control device, which can be integral with the body or remote from the body, usable to control the output of the display device and audio device(s). For example, the display and audio device(s) can be responsive to input from a separate remote control unit, or the footwear can include integrated buttons, switches, knobs, or similar devices usable to control the display and/or audio devices.

Through use of the present article of footwear, a user is thereby able to experience the convenience and luxury of live television and audio and/or video files in an extremely portable fashion, while displaying a changeable expression of affluence and an elevated lifestyle.

### BRIEF DESCRIPTION OF THE DRAWINGS

In the detailed description of the embodiments presented below, reference is made to the accompanying drawings, in which:

FIG. 1A depicts an embodiment of the present article of footwear having an integrated display device mounted within the tongue.

FIG. 1B depicts the footwear of FIG. 1A with the tongue and integrated display device of the footwear rotated and propped against the body of the footwear to facilitate viewing.

FIG. 2 depicts an alternate embodiment of the present article of footwear having an integrated display device mounted within the toe.

Embodiments of the present invention are detailed below with reference to the listed Figures.

### DETAILED DESCRIPTION OF THE EMBODIMENTS

Before explaining the present invention in detail, it is to be understood that the present invention is not limited to the particular embodiments described and depicted and that the present invention can be practiced or carried out in various ways.

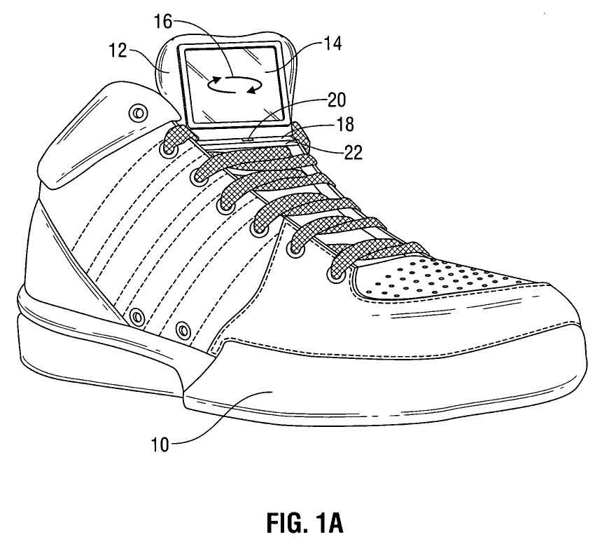

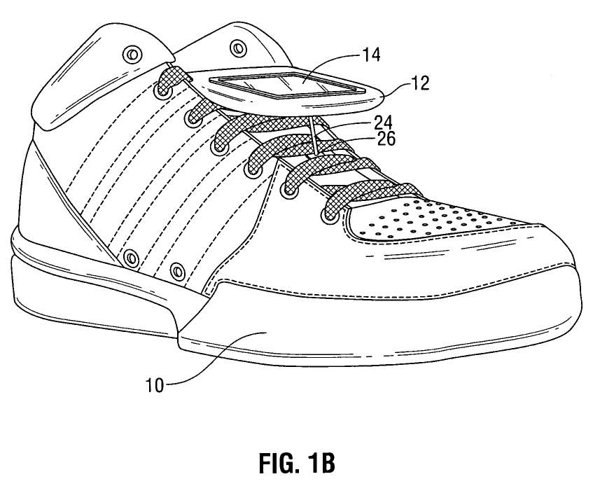

Referring now to FIG. 1A, a side perspective view of an embodiment of the present article of footwear is depicted.

The depicted footwear is shown having a body (10) adapted to be worn on an individual's foot. While the body (10) can be made from any material, including leather, canvas, rubber, suede, plastic, textiles, or other similar materials, FIG. 1 depicts the embodied footwear as a leather and canvas sneaker with a rubber sole and textile-based laces. To enhance the usable life of the footwear, the body (10) can include removable and replaceable soles and/or inserts. Other portions of the body (10) can also be replaceable. The body is shown having a tongue (12) disposed along its top.

The tongue (12) is shown having a display device (14) integrated thereon, the display device displaying an image (16). While any type of display device is usable within the scope of the present invention, FIG. 1 depicts the display device (14) as a liquid crystal display screen, having a length of about two to four inches and a height of about one to three inches. The display device can be thin and flexible, for enabling comfortable movement with the fabric or other flexible material of the tongue (12).

The display device (14) can include integrated speakers or other audio output devices, which can be disposed on the back or sides of the display device, or in another suitable location. The tongue (12) can be provided with perforations for facilitating transmission of sound from the audio devices through the footwear. The display device (14) can also include an integrated receiver, antenna, or a similar device, coupled with internal circuitry, for enabling the display device (14) to receive, process, and display live audio and video signals, such as network television broadcasts or radio broadcasts. The display device (14) can also include an integrated or remote processor and data storage for downloading, storing, and communicating audio and video files to the display device (14) for playback. Additionally, an integrated or separate remote control device (not depicted in FIG. 1) can be used to control the display device (14). Alternatively or additionally, the body (10) of the footwear could include buttons, switches, knobs, or other input devices for controlling the display device (14) and associated audio devices.

While FIG. 1 depicts an embodiment of the invention wherein speakers, a receiver, a processor, and data storage are integral with the display device (14), it should be noted that other embodiments of the invention can include audio devices, receivers, processors, and/or data storage media remote from the display device (14) and integrated elsewhere within the body (10) of the footwear, in wired or wireless communication with the display device (14). In a further embodiment of the invention, a processor and data storage for receiving and communicating audio and video files to the display device (14) can be remote from the body (10) and in communication with the display device (14) via an integral or separate receiver.

The display device (14) can be rotatably mounted to the tongue (12), to enable the display device (14) to have any selected orientation to facilitate viewing or decoration of the body (10). For example, when the footwear is worn, the display device could have a first orientation, such that displayed images have the proper orientation to onlookers, then the display device could be rotated to a second orientation, such that the displayed images have the proper orientation to the wearer to facilitate personal viewing.

The display device (14) can also be pivotably mounted to the tongue (12) to enable a portion of the display device to be raised and lowered with respect to the body (10), thereby facilitating viewing. In an embodiment, a portion of the display device (14) can be removable to facilitate safe transport and use of the depicted footwear, to deter theft, and/or to forego decoration of the body (10) using the display device (14). In a further embodiment of the invention, a removable portion of the display device (14) could be interchangeably installed within several different types of footwear. For example, both a pair of sneakers and a pair of dress shoes could include integrated circuitry and a mounting location for a screen, and the screen could be removed from the first pair of shoes and placed on the second when a wearer wishes to change shoes.

FIG. 1 depicts the tongue (12) movably attached to the body (10) due to a thin opening (18) between the tongue (12) and the body (10), which enables the tongue (12) to be rotated such that the display device (14) can be rotated to face the front or back of the body (10), or any direction therebetween. A rotating bracket (20) connects the tongue (12) to the body (10) to facilitate the free rotation of the tongue (12) and attached display device (14).

A locking bar (22) can be used to enable the tongue (12) to be tilted forward with respect to the body (10) to facilitate raising the display device (14) for viewing. The locking bar (22) can include internal and/or external gears and/or sprockets and an engaged pawl or similar device, enabling the tongue (12) to be tilted and locked in a variety of positions. Other locking mechanisms, such as Velcro™, and/or an extendable or severable part of the tongue (12) usable in a manner similar to an easel or tripod could also be used to selectively raise the display device (14).

Other means for movably mounting the display device (14) and/or the tongue (12), and for raising and lowering the display device (14) with respect to the tongue (12) can also be used without departing from the scope of the invention.

Referring now to FIG. 1B the footwear of FIG. 1A is depicted having the tongue (12) rotated and pivoted through use of the rotating bracket (not visible in FIG. 1B) and locking bar (not visible in FIG. 1B). An extendable member (24), which is depicted as a short length of plastic rod, is shown attached to the side of the tongue (12) opposite the display device (14). The extendable member (24) is secured to the top portion of the body (10) of the footwear at an attachment point (26). The attachment point can include a hole, loop, catch, fastener, or similar apparatus for engaging the distal end of the extendable member (24). In an embodiment of the invention, the extendable member (24) can include an end piece having a width sufficient for securing beneath the laces of the footwear. The extendable member (24) can be pivotably attached to the tongue (12) to enable retention of the display device (14) in a variety of pivotable orientations. Additionally, the extendable member (24) can be a telescoping member, enabling the tongue (12) and attached display device (14) to be pivotably raised and lowered to a variety of positions using the locking bar or a similar pivotable member.

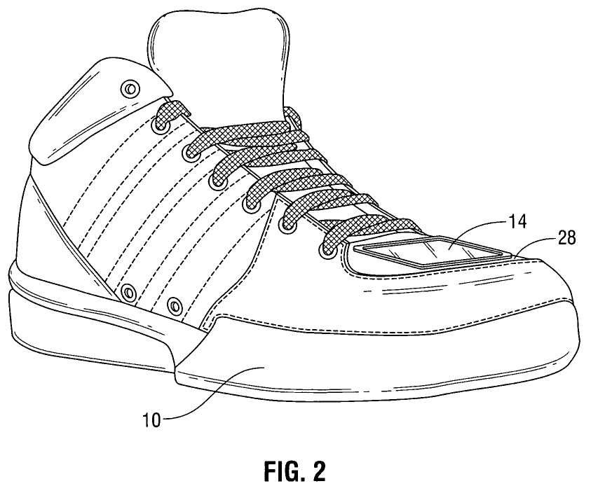

Referring now to FIG. 2, an alternate embodiment of the present article of footwear is shown, having the integrated display device (14) disposed on the toe (28) of the body (10) of the footwear. This embodiment can be of particular use when a wearer wishes to view the display device (14) while the footwear is worn, such as by propping his or her feet on a table or similar surface. As described previously, the display device (14) can be rotatably mounted, enabling the display device (14) to be provided with a first orientation when walking, such that images are viewed properly by onlookers, and with a second orientation to facilitate personal viewing. In an embodiment of the invention, the display device (14) could also be pivotably mounted to the toe (28), such as through use of a locking bar, a hinge-like attachment, or a similar pivotable fastener, enabling the display device (14) to be raised in a selected direction to enable viewing from a variety of orientations when the footwear is not worn.

Locations for integration of the display device other than those depicted in FIG. 1A, FIG. 1B, and FIG. 2 are also usable without departing from the scope of the invention. For example, a display device could be integrated with either side of an article of footwear, the heel of the footwear, the sole of the footwear, or any other location on the body of the footwear.

The embodiments herein thereby provide a luxury product that combines the conveniences of a portable television and video/music player that requires no separate carrying device due to its integration with footwear. The embodiments herein further provide a unique means by which a user can display signs of an affluent lifestyle, while selectively expressing oneself through the selection of individualized video and/or audio content for display.

While these embodiments have been described with emphasis on the embodiments, it should be understood that within the scope of the appended claims, the embodiments might be practiced other than as specifically described herein.

What is claimed is:

1. An article of footwear comprising:
a body adapted for being worn on a foot of an individual;
a display device integrated within the body;
at least one audio device integrated within the body, wherein said at least one audio device is in communication with the display device; and
a receiver integrated within the body, wherein the receiver is in communication with the display device and said at least one audio device, and wherein the receiver receives audio signals, video signals, or combinations thereof, and communicates the audio signals, video signals, or combinations thereof, to the display device and said at least one audio device.

2. The article of footwear of claim 1, further comprising a processor in communication with data storage for receiving, storing, and transmitting audio files, video files, or combinations thereof, to the display device, said at least one audio device, or combinations thereof.

3. The article of footwear of claim 2, wherein the processor, the data storage, or combinations thereof, are integrated within the body.

4. The article of footwear of claim 2, wherein the processor, the data storage, or combinations thereof, are in remote communication with the display device, said at least one audio device, or combinations thereof, using the receiver.

5. The article of footwear of claim 1, wherein the body comprises a tongue, a toe, or combinations thereof, and wherein the display device is disposed on the tongue or the toe.

6. The article of footwear of claim 5, wherein the tongue is rotatably disposed on the body for enabling viewing of the display device from multiple orientations.

7. The article of footwear of claim 6, wherein the tongue comprises a rotating bracket for enabling rotatable motion of the tongue and the display device.

8. The article of footwear of claim 5, wherein the tongue comprises a fastener, a locking device, at least one rotating and locking gear, or combinations thereof, for enabling the tongue to be secured in a raised position to facilitate viewing of the display device.

9. The article of footwear of claim 1, wherein the display device is rotatably mounted within the body, pivotably mounted within the body, or combinations thereof.

10. The article of footwear of claim 1, wherein said at least one audio device is integral with the display device.

11. The article of footwear of claim 1, wherein the receiver is adapted to receive network broadcast signals to enable a user to view live television.

12. The article of footwear of claim 1, further comprising a control device for controlling output of the display device and said at least one audio device.

13. The article of footwear of claim 12, wherein the control device is integral with the body.

14. The article of footwear of claim 12, wherein the control device is remote from the body.

15. The article of footwear of claim 1, wherein a portion of the display device, said at least one audio device, or combinations thereof, are detachable from the body.

16. An article of footwear comprising:
a body adapted for being worn on a foot of an individual;
a display device integrated within the body;
at least one audio device integrated within the body, wherein said at least one audio device is in communication with the display device;
a processor in communication with data storage, the display device, and said at least one audio device, wherein the processor receives audio files, video files, or combinations thereof, stores said files within the data storage, and transmits said files to the display device, said at least one audio device, or combinations thereof; and
an input device, a receiver, or combinations thereof in communication with the processor for controlling the receipt, storage, and transmission of the audio files, video files, or combinations thereof.

17. The article of footwear of claim 16, further comprising a receiver integrated within the body, wherein the receiver is in communication with the display device and said at least one audio device, and wherein the receiver receives audio signals, video signals, or combinations thereof and communicates the audio signals, video signals, or combinations thereof, to the display device and said at least one audio device.

18. The article of footwear of claim 17, wherein the processor, the data storage, or combinations thereof are in remote communication with the display device, said at least one audio device, or combinations thereof, using the receiver.

19. The article of footwear of claim 17, wherein the receiver is adapted to receive network broadcast signals to enable a user to view live television.

20. The article of footwear of claim 16, wherein the body comprises a tongue, a toe, or combinations thereof, and wherein the display device is disposed on the tongue or the toe.

21. The article of footwear of claim 20, wherein the tongue is rotatably disposed on the body for enabling viewing of the display device from multiple orientations.

22. The article of footwear of claim 21, wherein the tongue comprises a rotating bracket for enabling rotatable motion of the tongue and the display device.

23. The article of footwear of claim 20, wherein the tongue comprises a fastener, a locking device, or combinations thereof, for enabling the tongue to be secured in a raised position to facilitate viewing of the display device.

24. The article of footwear of claim 16, wherein the display device is rotatably mounted within the body, pivotably mounted within the body, or combinations thereof.

25. The article of footwear of claim 16, wherein said at least one audio device is integral with the display device.

26. The article of footwear of claim 16, further comprising a control device for controlling output of the display device and said at least one audio device.

27. The article of footwear of claim 26, wherein the control device is integral with the body.

28. The article of footwear of claim 26, wherein the control device is remote from the body.

29. The article of footwear of claim 16, wherein a portion of the display device, said at least one audio device, or combinations thereof, are detachable from the body.

30. A method for displaying an image comprising the steps of:
providing a display device integrated with an article of footwear;
displaying an image on the display device such that the image is visible when the article of footwear is worn; and
modifying the image.

31. The method of claim 30, wherein the step of displaying the image on the display device comprises receiving and processing a remote video signal, audio signal, or combinations thereof.

32. The method of claim 31, wherein the receiving and processing of the remote video signal, audio signal, or combinations thereof, comprises communicating with a television broadcast network to obtain a network television broadcast signal, communicating with a processor to obtain an audio or video file, or combinations thereof.
